(19) United States
(12) Patent Application Publication
(10) Pub. No.: US 2026/0110599 A1
(43) Pub. Date: Apr. 23, 2026

(54) VIBRATION MONITORING IN ORDER TO DETECT AN ERROR DURING A PROCESS AUTOMATION

(71) Applicant: IFM ELECTRONIC GMBH, Essen (DE)

(72) Inventors: Ali AJOUZ, Kreuztal (DE); Matthias KLEMM, Scheuerfeld (DE); Lukas BOGUNIA, Plettenberg (DE); Christian FRIEDRICH, Siegen (DE); Roger VARMA, Newtown Square, PA (US); Alexander HOFFMANN, Siegen (DE)

(21) Appl. No.: 19/148,516

(22) PCT Filed: Jan. 5, 2024
(86) PCT No.: PCT/EP2024/050234

§ 371 Date: Jul. 16, 2025

(30) Foreign Application Priority Data
Jan. 17, 2023 (EP) 23152059.4

(51) Int. Cl. G01M 99/00; G06F 17/18

(52) U.S. Cl. CPC G01M 99/005; G06F 17/18

(57) ABSTRACT

A computer-implemented monitoring method for analyzing vibrations to detect reliably a machine error during a process automation. The method includes a statistical analysis of at least one series of measured sensor data or at least one section thereof to ascertain a respective deviation of the measured sensor data according to at least three criteria. The statistical analysis provides a null hypothesis and an expected value and calculates the statistical significance with respect to a deviation from a specified null hypothesis in order to output a warning if the statistical significance deviates from the null hypothesis, and/or for a specified significance level α, the probability of a deviation from the null hypothesis is greater than the significance level α.

### CROSS-REFERENCE TO RELATED APPLICATIONS

This Application is a Section 371 National Stage Application of International Application No. PCT/EP2024/050234, filed Jan. 5, 2024, and published as WO 2024/153480 A1 on Jul. 25, 2024, not in English, which claims priority to and the benefit of European Patent Application No. 23152059.4, filed Jan. 17, 2023, the contents of which are incorporated herein by reference in their entireties.

### FIELD OF THE DISCLOSURE

The present disclosure relates to a computer-implemented monitoring method for vibration analysis for fault detection of a machine or hardware fault in process automation.

### BACKGROUND

It is known from the prior art to monitor processes executed by machine as to whether faults or failures occur in the employed machines, computers, etc. Sensors, which continuously record data during the process sequence, are typically used for this purpose, said data being evaluated according to a defined criterion in order to decide whether or not a fault is present. For example, detecting a fault state in an excitation circuit of an electric machine is known from DE 10 2018 222 562 A1, wherein the excitation current and the activation signal are filtered using reference values and compared as comparison signals acquired by sensors. A method for classifying the statistical dependence of a measurable time series is known from EP 0 934 567 A1, in which iterative tests using various null hypotheses are described.

A computer-implemented method for outputting a wear signal of a machine tool using so-called “change point detection” using distance metrics is in turn known from DE 10 2019 107 363 A1. However, this method is generally not reliable enough for long-term observations around-the-clock.

Furthermore, assessing the data quality on the basis of null hypotheses is also known from L. Shalalfeh et al., Fractional Dynamics of PMU Data (IEEE Transactions on Smart Grid, IEEE, USA, volume 12, no. 3, pages 1-11, May 2021), XP011850407, ISSN: 1949-3053, DOI: 10.1109/TSG.2020.3044903.

Furthermore, a method for diagnostic differentiation is known from EP 0 907 913 B1, in which regulating deviations are measured using a histogram, wherein different sources of interference can be concluded.

### SUMMARY

An exemplary aspect of the present disclosure is intended to be used in process automation for vibration analysis. For example, a machine having a rotor, such as a fan, can be examined for possible faults such as faulty deviations or the like developing slowly according to a trend by detecting the vibration and its deviations. Accordingly, the monitoring method according to an aspect of the disclosure for fault detection of a machine fault or a hardware fault, which results from a vibration analysis, in a process executed by machine, initially likewise comprises acquiring at least one series of sensor data measured during the process sequence. These data acquired by sensor are often recorded in chronological sequence. However, it is also conceivable, for example, that the series of sensor data represent a location sequence or a location course, for example if it is to be acquired by sensor whether the same distance is always maintained between two parts or whether a component does not depart from its intended mounting position due to heating, imbalance, or other irregularities.

The teaching of an aspect of the disclosure is distinguished in that the desired fault detection may also include fault prediction. In an aspect of the disclosure, it has been recognized that machine or hardware faults often “announce themselves” in particular during the monitoring of vibrations or rotations, i.e. a sudden spontaneous failure of the machine rarely occurs without any sign, instead symptomatic phenomena occur, which indicate the fault and are measurable, for example, because measured variables in conjunction with the machine/hardware change gradually. The changed measured variables can generally be acquired by sensor, such as an output current, an input current, a speed (for example, in a fan), etc. It is not uncommon for the machine or hardware to be able to continue its work, sometimes initially even without a loss of quality or without a noticeable loss of quality in the production, until the machine then suffers a greater failure.

In this respect, an aspect of the disclosure also makes it possible to optimize maintenance intervals, i.e. to predict in existing machine stocks when maintenance will be due and how long or short the maintenance intervals are to be set.

An aspect of the disclosure has recognized the difficulty that the measured sensor data are overlaid by statistical errors, in particular statistical noise, which makes it more difficult to evaluate individual measured sensor data, since these are subjected to statistical errors and can deviate from predetermined setpoint values, even though there is no fault.

It has been recognized that, for example, such a variable acquired by sensor does not change or changes only slowly on average, but the statistical variations of this variable around an expected value increase.

In addition, an aspect of the disclosure takes into consideration for the first time the fact that faults arising can often have effects on different aspects of the acquired sensor data. According to an aspect of the disclosure, statistical irregularities are therefore dealt with in the evaluation and examination, thus initially independently of the cause of the fault, because simple comparisons and acquisition of individual value deviations have proven to be an inadequate criterion in order to enable reliable fault detection. The method according to an aspect of the disclosure can therefore be used universally for a variety of applications since no special requirements are necessary with respect to the monitored machines and in general also only the general behavior to be expected of a measured variable acquired by sensor has to be known, even if it is only a value that is constant over time, for example.

According to an aspect of the disclosure, at least two, advantageously at least three, criteria are checked before a warning signal is output. As a basic criterion, which is assumed according to an aspect of the disclosure to be of fundamental importance in the fault detection, it is checked whether the measured data are constant up to a predetermined tolerance range. In order to be able to substantially parallelize the processing, in one exemplary embodiment, the criteria can even be determined at the same time if necessary and checked before a warning is output.

Since the basic criterion is of central importance and also represents the more general test, which is the main condition for a trend deviation or sudden deviation, with respect to other criteria such as a trend analysis or an examination for sudden changes, the basic criterion is also initially checked in a first step. Further criteria are only checked when this results in a deviation. These following criteria can also be evaluated in parallel chronologically for faster evaluation.

One exemplary an aspect of the disclosure therefore also advantageously provides a multilevel, at least three-level, warning system, in which a separate warning level is indicated depending on the number of criteria met in the fault detection. In this way, provision is simultaneously made of a monitoring method that performs weighting of the faults arising, so that the operator is made aware of the severity of the irregularities and can also evaluate more deliberately whether and using which measures an intervention is to be made in a process or the execution of a machine.

If the basic criterion is initially checked in a first step and other criteria are checked in a further step, the warning system can also advantageously be adapted thereto, that is to say can output an at least two-level warning that takes this classification into consideration.

An aspect of the disclosure is particularly suitable for the process automation of systems that are used in continuous operation and the vibration behavior or vibration properties of which are particularly relevant for the operation. The monitoring of vacuum pumps for clean room applications or the monitoring of fans operated in 24-hour operation, 7 days a week are mentioned as examples. An indication of damage beginning can advantageously be obtained very early from the inventive analysis of the vibration signal, so that the machine or installation can be repaired or maintained in a timely manner before more significant damage and failure occurs. The maintenance intervals can also be adapted from multiple such indications, namely if it can be estimated how frequently such damage occurs in the operating sequence and when it is to be expected. The system can be adapted very quickly for long-term monitoring operations for various applications. In one preferred refinement, vibration sensors are used as sensors to monitor, for example, fans, bearings, pumps, vacuum pumps, or other motors in continuous operation.

One advantageous application could exist, for example, in the area of medical technology, in which technical and biological processes interact, as a result of which statistical deviations are favored and fault detection requiring an intervention is all the more difficult to distinguish from a simple statistical deviation. Another advantageous application is in the field of cooling production processes (ventilators, fans, etc.).

According to an aspect of the disclosure, the expected value for the measured sensor data is calculated and provided. The expected value is required, for example, for statistical evaluation. The deviations of the measured sensor data may be related to the expected value. Said expected value describes a value that a random variable, in this case the sensor data, assumes on average, at least in relation to a certain time segment. Even if a trend is present, it is possible to check, for example, whether or not the deviation from the expected value becomes greater over time. The determination of the susceptibility to variation may also be related to the expected value.

According to an aspect of the disclosure, a statistical evaluation of at least one recorded series or a part of the at least one recorded series is therefore provided. In one advantageous exemplary embodiment, at least three criteria are additionally checked here in order to also be able to assign corresponding warning levels depending on how many of these criteria are met at once.

The monitoring method according to an aspect of the disclosure is generally carried out as a computer-implemented method, in which an electronic or computer-based evaluation of the sensor data is carried out. It therefore also overcomes the technical prejudice that signals afflicted by statistical errors or by noise cannot be evaluated statistically for errors and plausibility.

The statistical evaluation according to an aspect of the disclosure is carried out with development of a null hypothesis. If there is a deviation from the null hypothesis or if it is probable that there is a deviation from the null hypothesis above a predetermined significance level α, a warning is output.

In particularly preferred refinements of an aspect of the disclosure, for example, at least one of the following three criteria can be checked in the statistical evaluation:
A typical fault to be detected using statistical methods is that there is a jump of the mean sensor data level in chronological or locational sequence. This jump can be distinguished from individual deviations that are caused by noise and are therefore solely statistical, without there being a fault as such. There may be a fault such as this in the form of a jump, for example, if the variable to be measured is actually subjected to a suddenly occurring, but lasting, change, that is to say deviates from a stationary behavior. However, a sensor-related fault is also conceivable, for example, which results in this level deviation. The mean value, at least averaged over greater chronological or locational intervals, thus changes in the time curve.
A further fault to be detected using statistical methods may be that the measured sensor data change steadily according to a uniform trend (“running away”). A deviation from the stationary behavior is thus also present in this case. The mean value in the time curve changes continuously.
Even if the mean value remains constant averaged over greater chronological or locational intervals, the susceptibility to variation or volatility can vary quite strongly or in particular increase in the event of a fault, however.

In one an aspect of the disclosure, the behavior to be expected can be described by a model function composed of a sum of a function describing a stationary behavior, a function representing a random walk for modeling the noise, and a linear function describing a trend behavior with the time/the location distance, in order to be able to map typical effects such as background noise or drifting of the measured values. The measured values can therefore be described as follows:

$${y}_{t} = {c}_{t} + δ t + {u}_{t} ,$$

wherein yₜ represents the modeled measured data as a function of time t (or of the location), uₜ describes a stationary behavior, cₜ describes a random walk, for example, to simulate the noise, and δt describes a trend, thus “running away” or “drifting” of the measured values.

A statistical evaluation of the faults to be expected can be made mathematically comprehensible with respect to possible faults by way of this model description. Statistical variables such as the expected value, the standard deviation, or the variance can be calculated using this model description. In the case of a stationary behavior, the expected value can be determined by averaging. The deviations of the measured values from the model function, the residues, can also be calculated from the model.

Since a trend behavior of the measured values, in particular continuous drifting of the measured values, would represent a fault, initially δ=0 is assumed in the model.

The first criterion is a check as to whether a jump in the average measured data level takes place suddenly, a so-called level shift. In the case of stationary behavior, the variance is ideally=0. If noise underlies the measured values, the variance is around a determined expected value (ideally the mean value here). The volatility of the random walk component cₜ is equal to zero according to a null hypothesis and is different from zero only in the case of overall nonstationary behavior (also with consideration of underlying noise). In the case of nonstationary behavior, the expected value also fundamentally changes if it is redetermined over successive time intervals. In this case, viewed statistically, for example, a jump has taken place, this having shifted the measured values so significantly as a whole that a deviation from the expected value in the event of a determined variance as a result of underlying noise can no longer be explained by the noise behavior.

A stationary KPSS test can be used for the null hypothesis (KPSS: Kwiatkowski, Phillips, Schmidt and Shin):

For a number T of measured values, a test statistic for the null hypothesis

$$\frac{{\sum }_{t = 1}^{T} {S}_{t}^{2}}{{s}^{2} {T}^{2}}$$

can be assumed, wherein Sₜ is the sum of the residues eₜ

$${S}_{t} = {e}_{1} + {e}_{2} + {e}_{3} + … + {e}_{t}$$

at individual measurement points t (and in general at individual times t) with respect to the model function or regression curve and s2 is the variance with respect to the expected value. When checking the first criterion as to whether a level shift is present, it is generally advantageous to base this on a comparatively small amount of measured data, in order to form the sum in the test function therefrom, because it is accordingly also not necessary upon the comparison that the point at which a jump of the data potentially takes place is in the time or location interval to be checked. This test statistic follows a particular distribution. To test the null hypothesis, it can now be checked how probable the specified test statistic is. Below a certain probability or significance, it can be assumed that the null hypothesis does not apply. The significance level a, which is not supposed to be exceeded, can be assumed, for example, at 1%; otherwise the deviation from the test statistic is too great and a warning must be output.

If the volatility of the model function=0, a stationary behavior, possibly with underlying noise, is thus present.

To check the second criterion as to whether a trend curve is present or whether the measured data continuously “drift away”, it is generally necessary to evaluate and compare more measurement points. Otherwise, however, the KPSS test can also be applied for this criterion. As conditions, it is still presumed in the model function that δ=0, since otherwise a trend behavior has to be assumed, and autocorrelations are neglected.

If the significance is now lower than a specific predetermined value and a large amount of measured data were used, a trend behavior can be assumed; the second criterion is met.

The check of the first and second criterion can differ, however, solely due to the number of the test data or the measured time interval. It is accordingly checked here whether:
the volatility of the random walk term is greater than zero or greater in absolute value than the absolute value of a predetermined value and/or
the test statistic of the stationary KPSS test is maintained or not with a certain predetermined probability.

To check the third criterion as to whether the breadth of variation or susceptibility to variation continuously increases, it is sufficient to compare the variances in two different test phases or measured value ranges with one another. The null hypothesis to be checked is that the variances always correspond or at least only deviate with a predetermined probability. If the breadth of variation increases, the variance also increases in a following time interval or measurement interval. The amount of test data can be lower than in the checking of the second criterion for the trend course.

Viewed statistically, the significance can thus in turn be determined in relation to a defined probability value, wherein, if the significance falls below this probability value, the breadth of variation becomes greater and the third criterion is met.

### BRIEF DESCRIPTION OF THE DRAWINGS

Exemplary embodiments of the disclosure are shown in the drawings and will be explained in more detail hereinafter with specification of further details and advantages. In the specific figures:

FIG. 1: shows a schematic representation of a monitoring method for fault detection and fault prediction according to an aspect of the disclosure,

FIG. 2-4: show various measured data series, which are overlaid by noise, to illustrate the fault detection,

FIG. 5: shows a measured data series over a longer period of time, which is afflicted by different faults, including a representation of the fault terms,

FIG. 6: shows a schematic representation of a system used for machine monitoring of multiple vacuum pumps,

FIG. 7: shows a schematic representation of the parallel evaluation of three criteria before output of the warning signal, and

FIG. 8: shows a schematic representation of the evaluation in levels before output of the warning signal.

### DETAILED DESCRIPTION

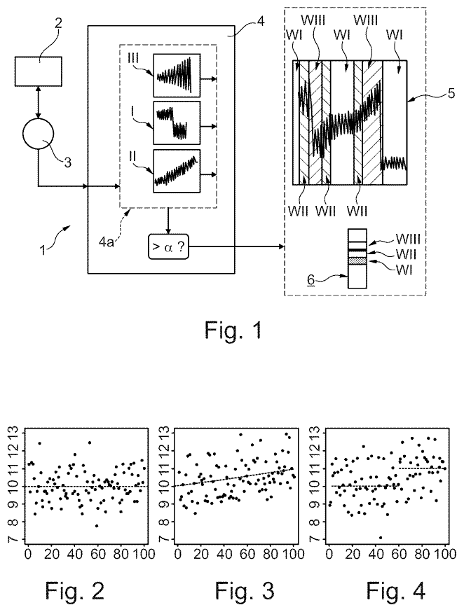

FIG. 1 shows a schematic representation of a computer-implemented monitoring method 1 for fault detection and fault prediction according to an aspect of the disclosure. An installation 2 is monitored by means of a sensor 3, which transmits the measured data to a computer-controlled evaluation unit 4. This evaluation unit 4 may be a control unit or controller, for example, within the machine; it can also run separately on a computer.

The evaluation unit 4 statistically evaluates the measured data:

Initially, it specifies a statistical significance level, for example, 1%, and furthermore at least one criterion. In this case, the evaluation unit 4 checks the basic criterion and three further criteria I, II, and Ill here in order to find out:
Is a fault-causing deviation present at all according to the basic criterion because the measured data are not constant within a predetermined tolerance?
First criterion I:
   Is a level shift present in the course of the measured data?
Second criterion II:
   Is a trend course present?
Third criterion III:
   Is a change in the volatility or susceptibility to variation present?

A so-called null hypothesis is taken as a basis for determining whether one of the criteria is met.

A model function is used as the basis for this purpose, which model function maps statistical errors, for example, via a random walk, but also has a term that can describe the behavior of the fundamentally undesired trend.

The trend behavior is initially considered not present, i.e. the term describing the trend is set equal to zero.

For an increase in volatility III, it is sufficient to examine the variances of two (chronologically successive) partial sequences acquired by sensor. Their ratio would ideally=1. Test statistics can also be used for the behavior and it is possible to check whether the measured value behavior is sufficiently similar to the test statistic.

In the case of the level shift behavior (criterion I), the expected value changes. It is also possible to work with a test statistic here. Not as much measured data are required here because the level shift is expected to take place rather quickly and therefore is not to be averaged over a longer period of time in order to be able to reliably acquire the signal change.

In the case of the trend behavior, which can also run very slowly, it is necessary to measure over a longer period of time to establish the change.

The evaluation of the significance and the determination of the deviation from the respective null hypothesis can be carried out in execution block 4a.

If the measured data are not constant enough within a tolerance limit (basic criterion K) and one of the criteria I, II, III is met, a first warning level WI is output by the evaluation unit 4. Similarly, with two criteria, a second, more critical warning level WII is signaled and, with three criteria, a particularly high warning level Will is signaled. The time course 5 of the measured data is indicated in FIG. 1, wherein the ranges WI, WII, WIII, in each of which one to three criteria are met, are indicated. It is also conceivable that a measure for the deviation from the respective null hypothesis is determined and the warning levels WI, WII or Will are selected accordingly.

The warning levels WI, WII, WIII can either only be indicated, for example, via a signal light or signal column 6; however, it is also conceivable, depending on the embodiment, that the evaluation unit 4 transmits corresponding control commands to the installation 2. These commands can also be adapted to which fault sources are typically present with specific criteria I, II, III.

Typically, it has to be presumed that recorded measured data of a measured data series are overlaid by noise, as is the case in each of FIGS. 2-4. Due to this overlaid noise, the measured data are so broadly distributed in individual sections of the measured data series that detecting faults such as a trend course or a level shift is made more difficult. In particular, the susceptibility to variation or volatility is also more difficult to detect purely graphically if the variance of the measured data caused by the noise is comparatively high and the measured values can vary on average with equal probability toward higher and lower values in comparison to a mean value or expected value.

FIG. 2 shows a signal that is clearly overlaid by noise, recorded as a measured data series. On average, the measured data remain at a constant level, however, this being shown as a dotted line. In spite of the high variance of the measured values, a uniform volatility is thus present in this case; this is because the variance also does not always become greater over the course of time, but rather the measured data remain in this section in the essentially uniform scattering around the average/expected value. Viewed over the period of time, no signal variations are thus present on average, except for statistical outliers of the measured values. A uniform volatility would be detected according to an evaluation according to the third criterion III.

FIG. 3 also shows a signal overlaid by noise. However, the measured values increase continuously over the course of time; a trend course is present. The dotted line, which reflects the mean values of the measured data, is a straight line with a positive gradient and indicates the rising level. However, since the statistical variations or the variance of the data is also high here, this trend is difficult to detect without evaluating a mean or expected value. This trend course is detected according to the second criterion II.

FIG. 4 shows an analogous situation with respect to FIGS. 2-3, i.e. a noisy signal is present, wherein it becomes clear with evaluation of the mean or expected value that a sudden jump of the measured values (level shift) to a higher level takes place in the course. The mean or expected value is represented by a dotted line with a sudden jump (level shift). Before and after this jump event, the measured data are in each case constant on average in these chronological partial ranges. An evaluation according to the first criterion I is accordingly relevant for this case.

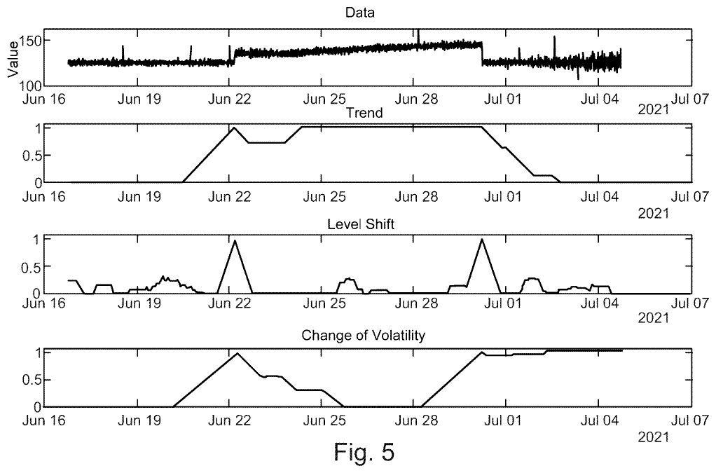

A course of a measured data series over a longer period of time of 19 days is represented in the first line of FIG. 5 (“value”). The other lines each describe, on a scale from 0 to 1, the terms in the model function that describe the trend course (criterion II), the level shift (criterion I), and the volatility (criterion III).

In the measured data course (“value”), it can be detected that the measured values are overlaid by statistical noise over the entire period of time. This noise also varies in its intensity, i.e. the variance is significantly greater in the range around July 4th, for example, than in the range of June 17th to approximately 20th. On average, however, the values are constant in the range from June 17th to approximately June 20th and the variations are statistically related in a smaller framework, which is shown in the last line of FIG. 5 in that the volatility assumes the value 0 up to June 20th. The value is also constant at 0 up to June 20th in the trend course in the second line, since the signal level does not change on average.

The behavior of the measured data from June 30th to July 5th is different. The deviations build up continuously here, while the signal level remains constant on average. The variance becomes greater. The buildup of the deviations increases the value of the volatility from June 30th. The constant signal level on average is shown by a trend value in the range of 0 in this period of time.

At two discrete points, namely at a time around June 22nd/23rd and around June 30th, the signal level changes suddenly, which is noticeable in the third line by an isolated peak at precisely this time in each case. Trend and volatility also each show changes at these times, also as singular peaks in the signal course, because the signal course (trend) has also changed with the jump or a deviation has taken place that also exceeds the variance here.

The measured signal increases continuously and rises slightly between June 22nd/23rd and June 30th. Therefore, in this period of time in line 2 of FIG. 5, the trend value is at values in the range 1, because a rising trend course is present.

The third line of FIG. 5 shows the term of the level shift, in which, as described above, above all the peaks in the range around June 22nd/23rd and around June 30th are noticeable. Outside these two peaks, the level term stays in the range around 0, but shows irregular deviations. This is because the measured signal (“value”) is not always statistically constant on average depending on which range is observed, i.e. the signal level that is subject to noise anyway changes somewhat.

Moreover, higher statistical variations occurring in the meantime and/or a change of the level, as in this case around June 22nd/23rd and around June 30th, may result in the value also briefly changing in the range of the volatility term and not being equal to 0, because the signal undergoes a change in the form of a jump, which is also greater than the variance caused by noise, i.e. the susceptibility to variation of the signal has also undergone a change here.

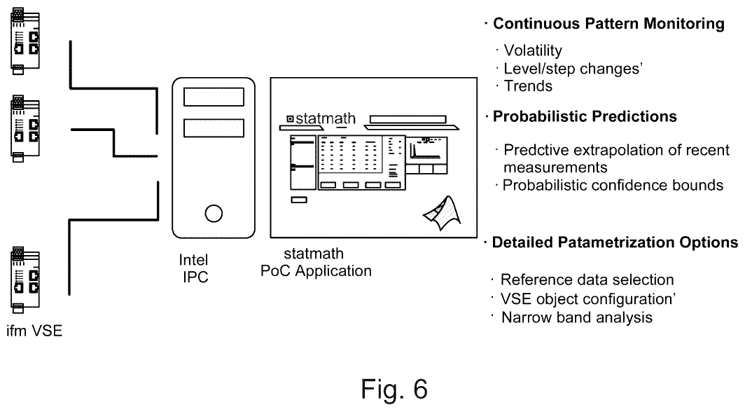

FIG. 6 shows a schema of a system for monitoring vacuum pumps using vibration sensors having diagnostic electronics for process monitoring. In this case, these are vibration sensors of the manufacturer type “ifm VSE”. The signals are transmitted to a processor for evaluation. Multiple cycles of the cyclic process are combined to form a machine cycle. The measured data is analyzed continuously (continuous pattern monitoring), assisted by numeric evaluation software, in order to analyze the volatility, changes in levels (level shifts), or trend courses. Mean or expected values are also calculated for this purpose. An extrapolation of the last measured data is carried out using methods of probability calculation to predict the data development, or it is checked whether the measured data lie with a specific probability in defined ranges of a confidence band or outside the confidence band.

This can be based selectively on a parameterization that provides a more detailed analysis according to specific criteria or parameters (detailed parameterization options), e.g.:
selection of reference data from the data set and/or
configuration of objects in the vibration analysis and/or
analysis with the aid of narrow confidence bands, in order to discover even minor deviations or stability of measured data.

The user generally has two options to train the pattern monitor, depending on the embodiment variant of an aspect of the disclosure:
Variant A: “Supervised”: The user manually marks existing patterns present in historic data, for example a trend that was present in a specific period of time in the historic data (or analogously for the volatility or a jump). The algorithm thereupon parameterizes itself so that precisely this period of time would have been detected and all other periods of time would not, if this is possible using the test methods. For this purpose, it is also checked whether the user has forgotten markings or has marked a range that does not have any patterns.
Variant B: “Unsupervised”: The user loads a period of time that is stationary and does not contain any of the patterns. The algorithm is then trained so that it would not have output an alarm/a warning signal in the selected period of time, but is parameterized as sensitively as possible here (for example narrow confidence band), that is to say would deflect in the case of the smallest changes/patterns. It is also checked in this case whether there are actually most certainly patterns in the data that the user has only forgotten to mark.

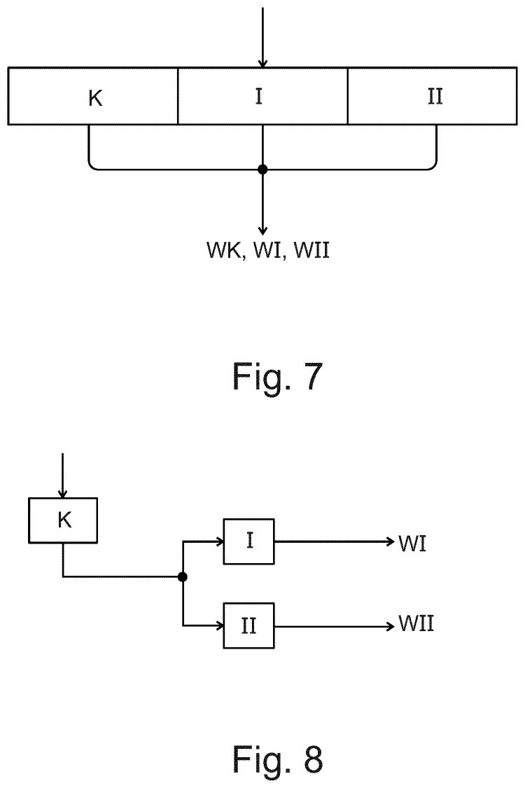

FIGS. 7 and 8 show two variants of the determination of the criteria. According to FIG. 7, three criteria are determined in parallel, among them the basic criterion K and the analysis of a trend Il and the occurrence of jumps I. Depending on which criterion is relevant, one of the warning notifications (or possibly also multiple warning notifications) WK, WI, WII is/are output.

FIG. 8 shows a determination of criteria in levels: Initially, the basic criterion K is checked, then the two other criteria I, II follow parallel to one another, if a deviation was established in this case. A two-level warning signal WI, WII is sufficient as output here, depending on whether the non-constant measured data show jumps or course trends.

The monitoring method according to an aspect of the disclosure advantageously enables a statistical evaluation of measured data to be performed, which measured data are partially also subjected, inter alia, to statistical errors, for instance are overlaid by noise, and to detect possible faults in this way. The method according to an aspect of the disclosure predominantly makes use of statistical methods and is largely universal, irrespective of the machine type/hardware type to be monitored, because fundamentally the occurrence of statistical errors is distinguished from faults caused by real malfunctions. According to an aspect of the disclosure, this is carried out with determination of deviations from a null hypothesis and the evaluation of a statistical significance in relation to a significance level to be predetermined. The classification into various categories on the basis of the number of fault criteria met and/or on the basis of the degree of the deviation enables, in one refinement, the classification of the severity of the situation.

An exemplary aspect of the present disclosure proposes a monitoring method for fault detection that enables particularly reliable fault detection.

An exemplary aspect of the present disclosure proceeds from previous monitoring methods known from the prior art, by the features of claim 1.

Exemplary aspects and refinements of the disclosure are possible by way of the measures mentioned in the dependent claims.

### REFERENCE OF REFERENCE SIGNS

1 Monitoring method
2 Installation to be monitored
3 Sensor
4 Evaluation unit
4a Significance calculation with respect to null hypothesis
5 Measured data with fault categorization
6 Signal column
1 Criterion (volatility)
II Criterion (level shift)
Criterion (trend behavior)
WI First warning level
WII Second warning level
WIII Third warning level
WK Basic warning level α Significance level
K Basic criterion

Although the present disclosure has been described with reference to one or more examples, workers skilled in the art will recognize that changes may be made in form and detail without departing from the scope of the disclosure and/or the appended claims.

1. A computer-implemented monitoring method for vibration analysis for fault detection of a machine fault and/or hardware fault in process automation in a production process operated and/or assisted by machine, comprising:
acquiring at least one series of sensor data measured in the process in a chronological and/or locational sequence;
performing a statistical evaluation of the at least one series or at least a part of the at least one series is performed in order to determine in each case a deviation of the measured sensor data according to at least three criteria (K, I, II, III),
wherein the statistical evaluation:
provides a null hypothesis,
provides an expected value for the measured sensor data,
provides a calculation of a statistical significance with respect to the deviation from the null hypothesis, and
outputs a warning if the statistical significance deviates from the null hypothesis and/or if, at a predetermined significance level α, the probability of a deviation from the null hypothesis is greater than the significance level α,
wherein
in the statistical evaluation, the deviations of the measured sensor data are determined according to the following criteria (K) before the warning is output: in the statistical evaluation, to test a basic criterion (K), it is checked whether a mean sensor data level in chronological and/or locational sequence remains constant within a tolerance predetermined by the basic criterion (K) and is also determined according to at least one of the following criteria (I, II, III),
i. in the statistical evaluation to test a second of the criteria (II), it is checked whether a trend of a continuous change of the mean sensor data level is present in chronological and/or locational sequence, and/or
ii. in the statistical evaluation to test a first of the criteria (I), it is checked whether a jump of the mean sensor data level is present in chronological and/or locational sequence, wherein, in particular, the jump has taken place when the jump shifts the measured values so significantly as a whole that the deviation from the expected value with a specific variance as a result of underlying noise can no longer be explained by a behavior of the noise, and/or
iii. in the statistical evaluation to test a third of the criteria (III), it is checked whether a susceptibility to variation in the series changes in chronological and/or locational sequence.

2. The computer-implemented monitoring method for vibration analysis as claimed in claim 1, wherein the basic criterion (K) is always checked in the statistical evaluation, wherein, in the statistical evaluation, the deviations of the measured sensor data according to the basic criterion (K) are carried out first, and then determined simultaneously or in a chronologically overlapping manner according to two or three of the other criteria (I, II, III).

3. The computer-implemented monitoring method for vibration analysis as claimed in claim 1, wherein, in the statistical evaluation, the deviations of the measured sensor data are determined according to the criteria (K, I, II, III) simultaneously and/or in a chronologically overlapping manner before the warning is output.

4. The computer-implemented monitoring method for vibration analysis as claimed in claim 1, wherein, in the statistical evaluation, the deviations of the measured sensor data are first carried out according to the basic criterion (K) and then determined simultaneously and/or in a chronologically overlapping manner according to two of the other criteria (I, II, III).

5. The computer-implemented monitoring method for vibration analysis as claimed in claim 1, wherein the statistical evaluation provides the output of an at least three-level warning, wherein each number of criteria met from the criteria (K, I, II, III) is assigned a warning level in each case.

6. The computer-implemented monitoring method for vibration analysis as claimed in claim 1, wherein the statistical evaluation provides the output of an at least two-level warning, depending on whether, in addition to the basic criterion, the first or second criterion also reveals a deviation.

7. The computer-implemented monitoring method for vibration analysis as claimed in claim 1, wherein the following function is used as a model function for the behavior of the sensor data in the series:
$${y}_{t} = {c}_{t} + δ t + {u}_{t} ,$$
wherein yₜ represents modeled sensor data as a function of t, cₜ describes a random walk, δ describes a trend and δₜ describes a linear trend behavior, and uₜ describes a stationary behavior when the sensor data of the series are plotted over t, wherein t describes a_chronological and/or locational course.

8. The computer-implemented monitoring method for vibration analysis as claimed in claim 7, wherein, to check the first criterion (I), the null hypothesis is used, the variance as the mean square deviation of the expected value and volatility of the random walk term cₜ is zero, wherein it is assumed, in particular with respect to the model function, that the trend δ=0.

9. The computer-implemented monitoring method for vibration analysis as claimed in claim 1, wherein, to check the first and/or second criterion (I), a stationary Kwiatkowski, Phillips, Schmidt and Shin (KPSS) test is carried out, comprising checking as the null hypothesis whether a test statistic is met with a predetermined probability, wherein, in particular, the following is used as the test statistic:
$$\frac{{\sum }_{t = 1}^{T} {S}_{t}^{2}}{{s}^{2} {T}^{2}}$$
as the sum of the squares of the sum Sₜ over the part T of the sequence, wherein Sₜ is in turn the sum of residues in relation to a regression curve of the measured sensor data at individual points t, in relation to the product of variance s² multiplied by the square of the number of a sequence part T, wherein a warning is output if the test statistic is not met with less than a predetermined probability.

10. The computer-implemented monitoring method for vibration analysis as claimed in claim 1, wherein, to check the first and/or the second criterion and/or the basic criterion (I, II, K), autocorrelations are used, which are taken into consideration and/or calculated out and/or neglected in particular in signal delays in the form of sensor data influenced by delay.

11. The computer-implemented monitoring method for vibration analysis as claimed in claim 1, wherein a larger part of the sequence having more sensor data is used to check the second criterion (II) than to check the first criterion (I).

12. The computer-implemented monitoring method for vibration analysis as claimed in claim 1, wherein, to check the third criterion (III), at least two partial sequences of sensor data are recorded.

13. The computer-implemented monitoring method for vibration analysis as claimed in claim 1, wherein, to check the third criterion (III), a test statistic F is used as the null hypothesis, which forms a ratio of the variances of the two test sequences, and it is assumed as the null hypothesis that F=1.

14. The computer-implemented monitoring method for vibration analysis as claimed in claim 1, wherein the statistical evaluation provides the output of an at least two-level warning, wherein the warning is transmitted to a signal column, wherein:
each warning level is assigned a different light sign on the signal column as a function of the number of warnings and/or
a different light sign on the signal column is assigned depending on the deviation from the null hypothesis.

15. The computer-implemented monitoring method for vibration analysis as claimed in claim 1, wherein, upon acquisition, the data of a period of time are loaded, which is stationary and in particular does not contain any of patterns, wherein the algorithm is subsequently trained so that the algorithm would not have output an alarm and/or warning signal in the selected period of time, but at the same time is parameterized to deflect in an event of changes and/or patterns.
